(19) United States
(12) Patent Application Publication
(10) Pub. No.: US 2025/0172765 A1
(43) Pub. Date: May 29, 2025

(54) CYLINDRICAL MULTI-CORE FERRULE AND OPTICAL CONNECTOR

(71) Applicant: NIPPON TELEGRAPH AND TELEPHONE CORPORATION, Tokyo (JP)

(72) Inventors: Chisato FUKAI, Musashino-shi, Tokyo (JP); Yoshiteru ABE, Musashino-shi, Tokyo (JP); Kazunori KATAYAMA, Musashino-shi, Tokyo (JP)

(73) Assignee: NIPPON TELEGRAPH AND TELEPHONE CORPORATION, Tokyo (JP)

(21) Appl. No.: 18/844,001

(22) PCT Filed: Mar. 17, 2022
(86) PCT No.: PCT/JP2022/012434

§ 371 Date: Sep. 4, 2024

(51) Int. Cl. G02B 6/38

(52) U.S. Cl. CPC G02B 6/3885

(57) ABSTRACT

An object of the present disclosure is to enable a plurality of single-core optical fibers to be easily and collectively connected.

The present disclosure is: a cylindrical multi-fiber ferrule having a cylindrical shape in which a plurality of through holes are formed on the same circle centered on a central axis of the cylindrical shape, each of the through holes being configured to hold a single-core optical fiber; and an optical connector in which a plurality of the cylindrical multi-fiber ferrules are arranged facing each other, and there is a gap between end surfaces of the single-core optical fibers held by the respective cylindrical multi-fiber ferrules.

### TECHNICAL FIELD

The present disclosure relates to a cylindrical multi-fiber ferrule used for collectively connecting a plurality of ports using optical fibers in an optical fiber network and an optical connector using the cylindrical multi-fiber ferrule.

### BACKGROUND ART

As a technology of connecting a plurality of single-mode optical fibers, there is a multi-fiber optical connector (for example, Non Patent Literature 1). The optical connector enables easy attachment and detachment in connection of optical fibers, and is useful for wiring switching in a building, connection to a device that needs to be replaced every several years, and the like. In a general multi-fiber optical connector, two guide holes are provided in a ferrule having a rectangular tip end portion, and a guide pin is inserted into the guide hole to perform connection. Axial adjustment is performed by the guide hole and the guide pin, and a connection loss of 1 dB or less is realized by controlling the clearance between the guide hole and the guide pin. Furthermore, there has also been developed an optical connector (for example, Non Patent Literature 2) in which reflection characteristics are improved by obliquely polishing the ferrule tip end portion, and convenience is improved by providing a housing and attaching and detaching the housing by a push-pull mechanism.

On the other hand, in an optical connector using a cylindrical ferrule generally used as a technique for connecting optical fibers, the ferrule is inserted into a sleeve to perform connection. Generally, a split sleeve is used as the sleeve, and the inner diameter of the split sleeve is made smaller than the outer diameter of the ferrule to improve accuracy of axial adjustment, and a connection loss of 0.5 dB or less is realized in a single-fiber optical connector. As a technology of collectively connecting a plurality of ports of an optical fiber in an optical connector using a cylindrical ferrule, an optical connector using a multicore fiber (for example, Non Patent Literature 3) has been studied. In addition, an SC type (for example, Non Patent Literature 4) optical connector with improved axial rotation accuracy has also been studied.

However, in the conventional technique described in Non Patent Literature 1 described above, since the fiber position of each fiber at the ferrule tip end portion is not constant due to an error in the manufacturing process, physical contact on the entire core wire is difficult, and the reflection characteristics are deteriorated. Therefore, it is generally necessary to apply a refractive index matching material and use a dedicated tool for attachment and detachment, and there is a problem in that the operation process is complicated.

In the conventional technology disclosed in Non Patent Literature 2, it is difficult to control a clearance between the guide hole and the guide pin, and there is a problem in that the manufacturing of a low-loss optical connector increases the cost.

In the conventional technology disclosed in Non Patent Literature 3 and Non Patent Literature 4, it is necessary to use a multicore fiber to collectively connect a plurality of ports using a cylindrical ferrule, but multicore fibers are expensive, and there is a problem in that a wiring form becomes complicated because it is necessary to use a device such as a fan-in/fan-out in wiring between normal transmission/reception devices assumed to be connected to a single-core optical fiber.

### CITATION LIST

### Non Patent Literature

Non Patent Literature 1: M. Kawase, T. Fuchigami, M. Matsumoto, S. Nagasawa, S. Tomita, and S. Takashima, “Subscriber Single-Mode Optical Fiber Ribbon Cable Technologies Suitable for Mdspan Access”, J. Lightwave Technol., vol. 7, no. 11, pp. 1675-1681, 1989.
Non Patent Literature 2: M. Kihara, S. Nagasawa, and T. Tanifuji, “Design and Performance of an Angled Physical Contact Type Multifiber Connector”, J. Lightwave Technol., vol. 14, no. 4, pp. 542-548, 1996.
Non Patent Literature 3: Katsuyoshi Sakaime, Ryo Nagase, Kengo Watanabe, and Tsunetoshi Saito, “Mechanical characteristic of MU-Type MCF connector”, IEICE Technical Report, OCS2013-118, pp. 97-100, 2014.
Non Patent Literature 4: Tetsuya Kobayashi, Haruyuki Endo, Yosuke Minagawa, “Study on multicore fiber connectors”, IEICE Technical Report, OCS2014-33, pp. 13-16, 2014.

### SUMMARY OF INVENTION

### Technical Problem

An object of the present disclosure is to enable a plurality of single-core optical fibers to be easily and collectively connected.

### Solution to Problem

In a cylindrical multi-fiber ferrule of the present disclosure, the cylindrical multi-fiber ferrule having a cylindrical shape, a plurality of through holes are formed on the same circle centered on a central axis of the cylindrical shape, each of the through holes being configured to hold a single-core optical fiber, and
one tip end portion on the central axis has a convex spherical shape.

In an optical connector of the present disclosure, a plurality of the cylindrical multi-fiber ferrules of the present disclosure are arranged facing each other, and the one tip end portions of two of the cylindrical multi-fiber ferrules arranged to face each other are butted against each other.

According to the present disclosure, it is possible to easily and collectively connect a plurality of single-core optical fibers, and thus, it is possible to achieve economical optical connection.

### BRIEF DESCRIPTION OF DRAWINGS

FIG. 1 is a schematic diagram illustrating a ferrule cross section according to an embodiment of the present disclosure.

FIG. 2 is a schematic diagram illustrating a side surface of an optical coupling portion according to the embodiment of the present disclosure.

FIG. 3 is a schematic diagram illustrating a vicinity of a ferrule tip end portion of the optical coupling portion according to the embodiment of the present disclosure.

FIG. 4 is a diagram illustrating an example of a relationship between an angle formed by a plane perpendicular to a ferrule central axis and a fiber end surface and a reflection attenuation amount.

FIG. 5 is a diagram illustrating an example of a relationship of excess loss with respect to a gap of an optical fiber.

FIG. 6 is a diagram illustrating an example of a relationship between the curvature radius of the ferrule tip end portion having a convex spherical shape and the angle formed by the plane perpendicular to the ferrule central axis and the fiber end surface.

FIG. 7 is a diagram illustrating an example of a relationship between the curvature radius of the ferrule tip end portion having the convex spherical shape and the distance from the ferrule tip end portion to the fiber end surface.

FIG. 8 is a diagram illustrating an example of a relationship of excess loss due to a rotational angle deviation with respect to a core arrangement radius.

FIG. 9 is a schematic diagram illustrating a fitting form of an optical connector according to a first embodiment of the present disclosure.

FIG. 10 is a diagram illustrating an example of a configuration in which a plurality of capillaries are attached inside a flange.

FIG. 11 is a diagram illustrating an example of a configuration in which a flange is attached to a ferrule.

FIG. 12 is a schematic diagram illustrating a mechanism capable of rotating and fixing the ferrule inside a plug frame according to the first embodiment of the present disclosure.

FIG. 13 is a schematic diagram illustrating a mechanism capable of rotating and fixing the ferrule inside the plug frame according to the first embodiment of the present disclosure.

FIG. 14 is a schematic diagram illustrating a mechanism capable of rotating and fixing the ferrule inside the plug frame according to a second embodiment of the present disclosure.

### DESCRIPTION OF EMBODIMENTS

Hereinafter, embodiments of the present disclosure will be described in detail with reference to the drawings. Note that the present disclosure is not limited to the following embodiments. These embodiments are merely examples, and the present disclosure can be carried out in forms of various modifications and improvements based on knowledge of those skilled in the art. Further, configurational components having the same reference numerals in this specification and the drawings denote the same configurational components.

Hereinafter, embodiments of the present disclosure will be described in detail with reference to the drawings.

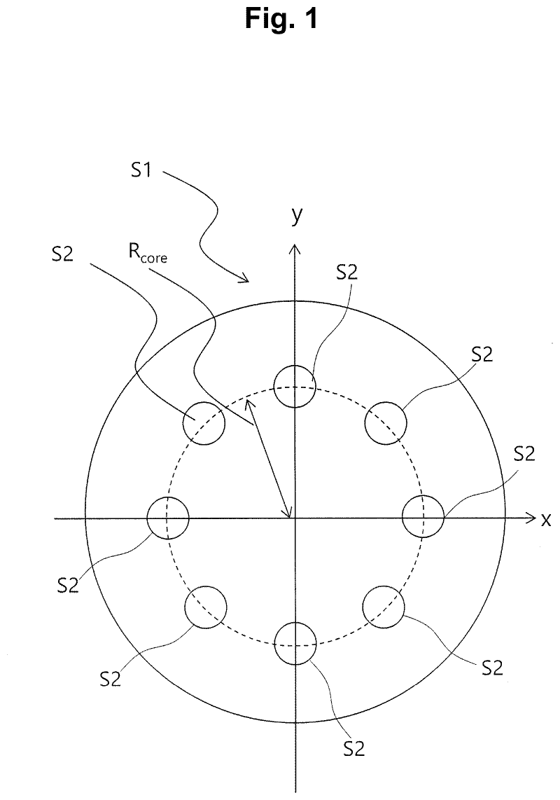

FIG. 1 is a schematic diagram illustrating a cross-sectional structure of a ferrule S1 according to an embodiment of the present disclosure. The ferrule S1 is a cylindrical multi-fiber ferrule according to the present disclosure, has a cylindrical shape, and has a plurality of through holes for holding optical fibers S2 in parallel with the longitudinal direction of the cylindrical shape. FIG. 1 illustrates a state in which the optical fiber S2 is held in each through hole. The core centers of the plurality of optical fibers S2 are arranged on the circumference of a circle having a core arrangement radius R_{core} with respect to the central axis of the cylindrical shape of the ferrule S1.

Here, the optical fiber S2 in the present disclosure is a single-core optical fiber. Although FIG. 1 illustrates an example in which the eight optical fibers S2 are arranged at equal intervals, the core centers of the plurality of optical fibers S2 may be arranged on the circumference of the circle having the core arrangement radius R_{core}, and the arrangement is not limited thereto. In the present embodiment, an example in which the plurality of optical fibers S2 are arranged on one circumference is described, but the plurality of optical fibers S2 may be arranged in two or more circles.

In the present embodiment, the ferrule S1 is generally made of zirconia, and the optical fiber S2 is made of quartz glass. However, the ferrule and the optical fiber may be any ferrule and optical fiber that can communicate signal light in a communication wavelength band, and the ferrule and the optical fiber are not limited thereto.

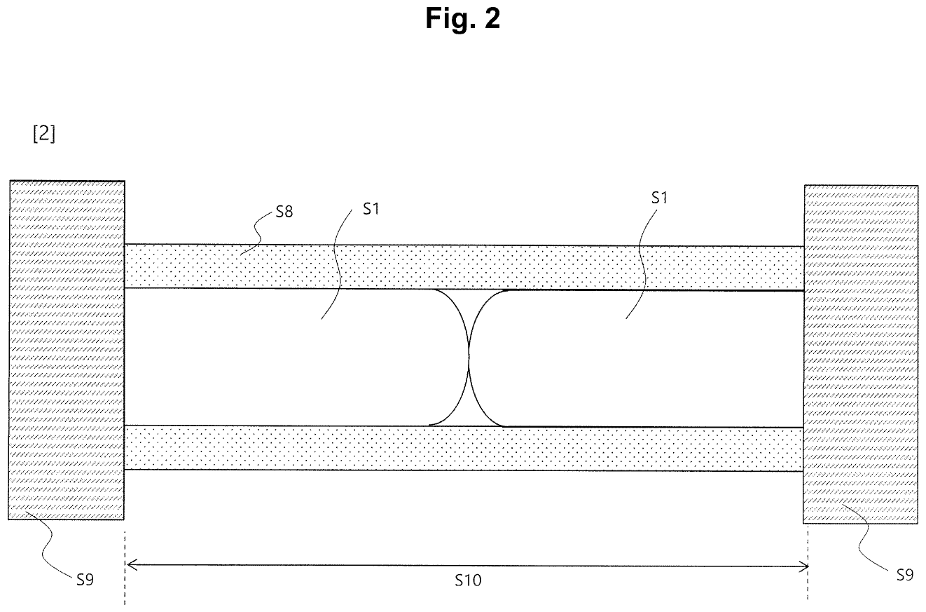

FIG. 2 is a schematic diagram illustrating a side surface of an optical coupling portion according to the embodiment of the present disclosure. The two ferrules S1 into which the optical fibers are inserted are aligned by a sleeve S8, and the axial deviation is controlled within a certain allowable range. In order to minimize the connection loss in the optical coupling portion, it is desirable that the cores of the plurality of optical fibers inserted into the two ferrules S1 have the same optical characteristics in terms of having similar mode field diameters. In addition, it is important that the cores of the optical fibers inserted into the two ferrules S1 are arranged on the circumference having the same core arrangement radius at the respective ferrule tip end portions, and connection loss due to axial deviation and rotational deviation is minimized, and it is desirable that the optical fibers are arranged at positions facing each other. In order to minimize the connection loss due to axial deviation, it is desirable that the ferrule outer diameters of the two ferrules S1 are substantially the same. In addition, in order to reduce the gap between the end surfaces of the optical fibers inserted into the two ferrules S1 as much as possible to reduce the excess loss due to the gap, it is important that the tip end portions of the two ferrules S1 (hereinafter, each may be referred to as a ferrule tip end portion) can come into contact with each other, and a length S10 in the sleeve axial direction is desirably about the same as or shorter than the sum of the lengths in the ferrule axial direction of the two ferrules S1.

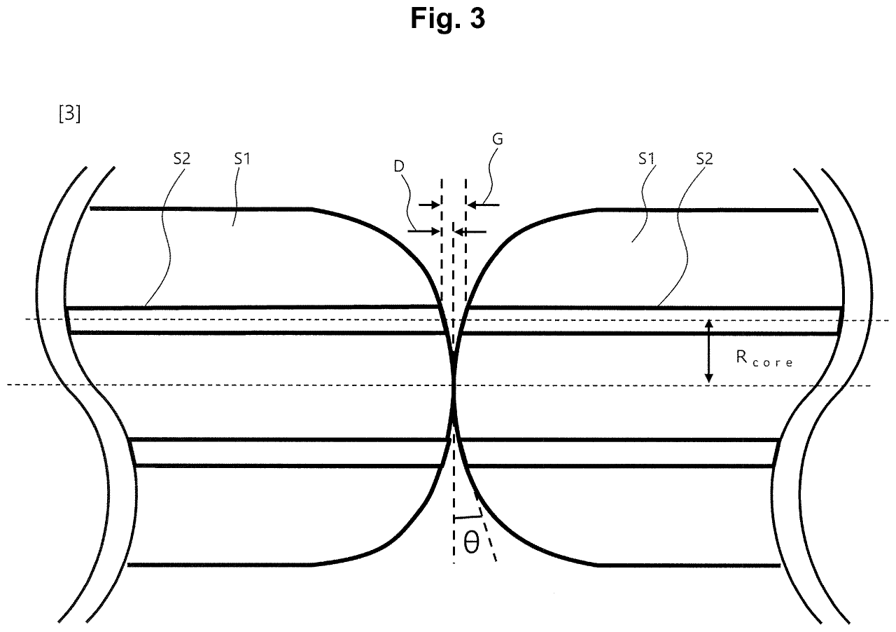

FIG. 3 is a schematic diagram illustrating the vicinity of the ferrule tip end portions of the optical coupling portion according to the embodiment of the present disclosure in more detail. The tip end portions of the two ferrules S1 have a convex spherical shape in the central axis direction. The tip end portions of the ferrules S1 are butted against each other. Each of the plurality of optical fibers S2 is disposed at a position of the core arrangement radius R_{core} in the ferrule cross section. The fiber end surface of the optical fiber S2 is set back from the ferrule tip end portion in order to prevent damage due to contact between the fiber end surfaces. In addition, in the end surface of the optical fiber S2, an angle θ formed between a plane perpendicular to the ferrule central axis and the fiber end surface is controlled in order to suppress signal characteristic deterioration due to reflection.

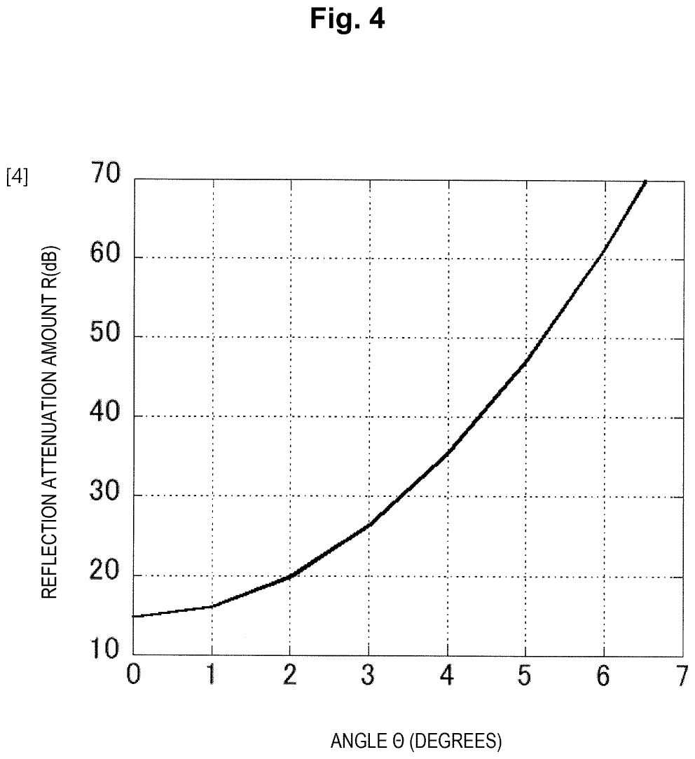

FIG. 4 is a diagram illustrating an example of a relationship between an angle θ formed by the plane perpendicular to the ferrule central axis and the fiber end surface and a reflection attenuation amount R. In optical coupling between optical fibers, when there is a region having a different refractive index between fiber end surfaces, signal characteristics are deteriorated due to reflection. In the configuration of the optical coupling portion of the present disclosure, there is a gap between the end surfaces of the respective optical fibers S2 inserted into the two ferrules S1, and quartz glass and air have different refractive indexes. Therefore, it is necessary to devise a way to reduce reflection. In the present disclosure, reflection is reduced by controlling the angle θ. The relationship between the angle θ (unit: degree) formed by the plane perpendicular to the ferrule central axis and the fiber end surface and the reflection attenuation amount R (unit: dB) can be expressed by Math. 1.

$$[ Math . 1 ]$$

$$R = 10 \frac{{( π \times {n}_{1} \times {ω}_{1} )}^{2}}{{λ}^{2}} \times log ( e ) \times {( 4 π \frac{θ}{360} )}^{2} + {R}_{0} \qquad ( 1 )$$

Here, n₁, ω₁, and λ are the refractive index of the optical fiber S2, the mode field radius (unit: μm) of the optical fiber core, and the wavelength (unit: μm) of the propagated light in vacuum, respectively.

R₀ is a reflection attenuation amount (unit: dB) in the case of θ=0 degrees, and can be expressed by the following expression.

$$[ Math . 2 ]$$

$${R}_{0} = - 10 \times log [ {( \frac{{n}_{1} - {n}_{2}}{{n}_{1} + {n}_{2}} )}^{2} ] \qquad ( 2 )$$

Here, n₂ is the refractive index of a light receiving medium, that is, the refractive index of air. In the present embodiment, a case where the reflection attenuation amount R₀ at θ=0 is 14.7 dB when the wavelength λ is 1310 nm and the mode field radius ω₁ is 4.5 μm will be described. In this case, from the result illustrated in FIG. 4, for example, by setting the angle θ formed by the plane perpendicular to the ferrule central axis and the fiber end surface to 4.5 degrees or more, it is possible to maintain the reflection attenuation amount R of 40 dB or more.

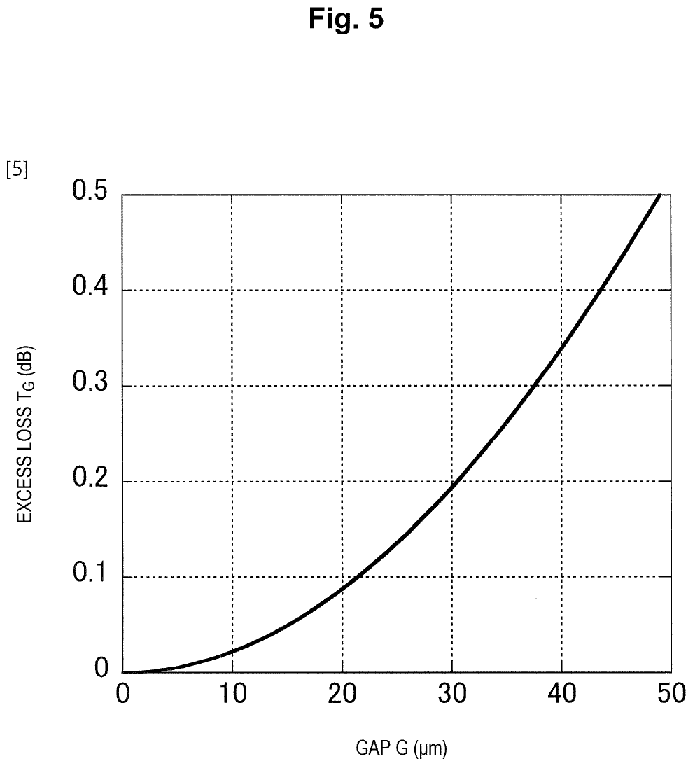

FIG. 5 is a diagram illustrating an example of a relationship of excess loss T_{G} with respect to a gap G of the optical fibers. In the optical coupling between the optical fibers S2, if the gap exists between the optical fiber end surfaces, a distribution of emitted light of the input-side optical fiber is widened, and coupling efficiency with the core of the output-side optical fiber is reduced, which causes excess loss. The relationship between the gap G (unit: μm) and the excess loss T_{G} (unit: dB) can be expressed by the following expression.

$$[ Math . 3 ]$$

$${T}_{G} = \qquad ( 3 )$$

$$- 10 \times log \{ \frac{4 [ 4 {( \frac{G λ}{2 π {n}_{clad} {ω}_{1} {ω}_{2}} )}^{2} + \frac{{ω}_{1}^{2}}{{ω}_{2}^{2}} ]}{{[ 4 {( \frac{G λ}{2 π {n}_{clad} {ω}_{1} {ω}_{2}} )}^{2} + \frac{{ω}_{2}^{2} + {ω}_{1}^{2}}{{ω}_{2}^{2}} ]}^{2} + 4 {( \frac{G λ}{2 π {n}_{clad} {ω}_{1} {ω}_{2}} )}^{2} \frac{{ω}_{2}^{2}}{{ω}_{1}^{2}}} \}$$

Here, λ, n_{clad}, ω₁, and ω₂ are the wavelength (unit: μm) of propagated light in vacuum, the refractive index of the cladding of the optical fiber S2, that is, pure quartz, and the mode field radius (unit: μm) of the input-side and output-side optical fiber cores, respectively. FIG. 5 is a diagram illustrating a loss when the mode field radii of the cores of the optical fibers inserted into the two ferrules are both 4.5 μm. For example, by adjusting the gap between the end surfaces of the optical fibers S2 inserted into the two ferrules to 22 μm or less, the excess loss can be suppressed to 0.1 dB or less.

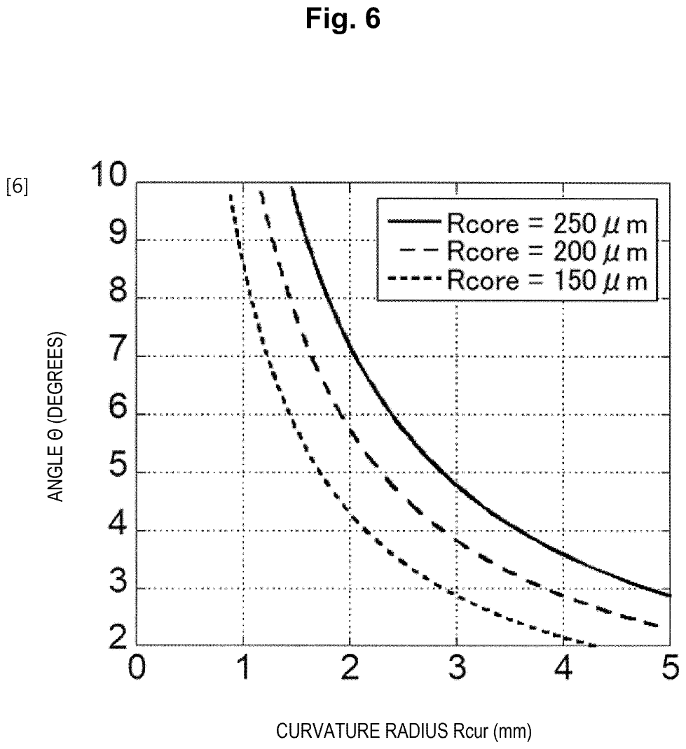

FIG. 6 is a diagram illustrating an example of a relationship between the curvature radius Rcur of the ferrule tip end portion having a convex spherical shape and the angle θ formed by the plane perpendicular to the ferrule central axis and the fiber end surface. The relationship between the curvature radius Rcur (unit: mm) of the ferrule tip end portion of the convex spherical shape and the angle θ (unit: degree) formed by the plane perpendicular to the ferrule central axis and the fiber end surface can be expressed by the following expression using the core arrangement radius Rcore (unit: μm).

$$[ Math . 4 ]$$

$${R}_{cur} = \frac{{R}_{core}}{sin θ} \qquad ( 4 )$$

FIG. 6 is a diagram illustrating a relationship between the angle θ and the curvature radius Rcur when the core arrangement radius Rcore is 150, 200, or 250 μm. From FIG. 4, the angle θ at which the reflection attenuation amount R of 40 dB or more can be maintained is 4.5 degrees or more. Therefore, from FIG. 6, it can be seen that the curvature radius Rcur with which the angle θ is 4.5 degrees or more can be realized in the core arrangement radius Rcore of 250 μm or less. For example, when the core arrangement radius Rcore is 150 μm, 200 μm, or 250 μm, by adjusting the curvature radius Rcur to be 1.9 mm or less, 2.5 mm or less, or 3.2 mm or less, respectively, the angle θ becomes 4.5 degrees or more, and the reflection attenuation amount R of 40 dB or more can be maintained.

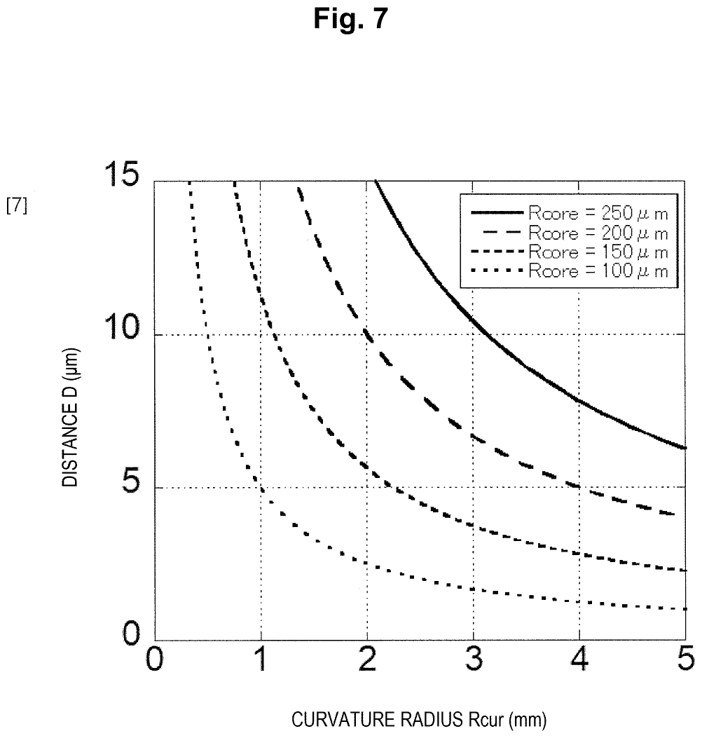

In addition, FIG. 7 is a diagram illustrating an example of a relationship between the curvature radius Rcur of the ferrule tip end portion having the convex spherical shape and a distance D from the ferrule tip end portion to the fiber end surface. The distance D from the ferrule tip end portion to the fiber end surface corresponds to a half of the gap G between the end surfaces of the two optical fibers S2, and can be expressed by the following expression using the curvature radius Rcur (unit: mm) of the ferrule tip end portion having a convex spherical shape and the angle θ (unit: degree) formed between the plane perpendicular to the ferrule central axis and the fiber end surface.

$$[ Math . 5 ]$$

$$D = \frac{G}{2} = {R}_{cur} - ( {R}_{cur} \times cos θ ) \qquad ( 5 )$$

FIG. 7 is the diagram illustrating the relationship between the curvature radius Rcur and the distance D from the ferrule tip end portion to the fiber end surface when the core arrangement radius R_{core} is 150, 200, or 250 μm. For example, when the core arrangement radius Rcore is 100 μm, 150 μm, 200 μm, or 250 μm, by adjusting the curvature radius Rcur to be 0.5 mm or more, 1.1 mm or more, 2.0 mm or more, or 3.1 mm or more, respectively, the distance D from the ferrule tip end portion to the fiber end surface becomes 10 μm or less, that is, the gap G becomes 20 μm or less, and as illustrated in FIG. 5, the excess loss T_{G} due to the gap can be suppressed to 0.1 dB or less.

In order to obtain a reflection attenuation amount of 40 dB or more and an excess loss due to a gap of 0.1 dB or less, the optical coupling portion according to the present embodiment may include,
in each of the two ferrules S1,
a curvature radius of the convex spherical shape of 0.5 mm or more and 3.2 mm or less.

In the configuration of the optical coupling portion of the present disclosure, rotational angle deviation at the time of manufacturing the optical connector causes excess loss. In a case where the excess loss due to the rotational angle deviation is denoted by T_{R} (unit: dB), the rotational angle deviation is denoted by Φ (unit: degree), the core arrangement radius is denoted by R_{core} (unit: μm), and the mode field radii of the cores of the input-side optical fiber and the output-side optical fiber are denoted by ω₁ and ω₂ (unit: μm), respectively, the relationship of these elements can be expressed by the following expression.

$$[ Math . 6 ]$$

$${T}_{R} = - 10 log \{ {( \frac{2 {ω}_{1} {ω}_{2}}{{ω}_{1}^{2} + {ω}_{2}^{2}} )}^{2} exp [ - 1 \times \frac{2 {( 2 {R}_{core} sin 2 π \frac{Φ}{360} )}^{2}}{{ω}_{1}^{2} + {ω}_{2}^{2}} ] \} \qquad ( 6 )$$

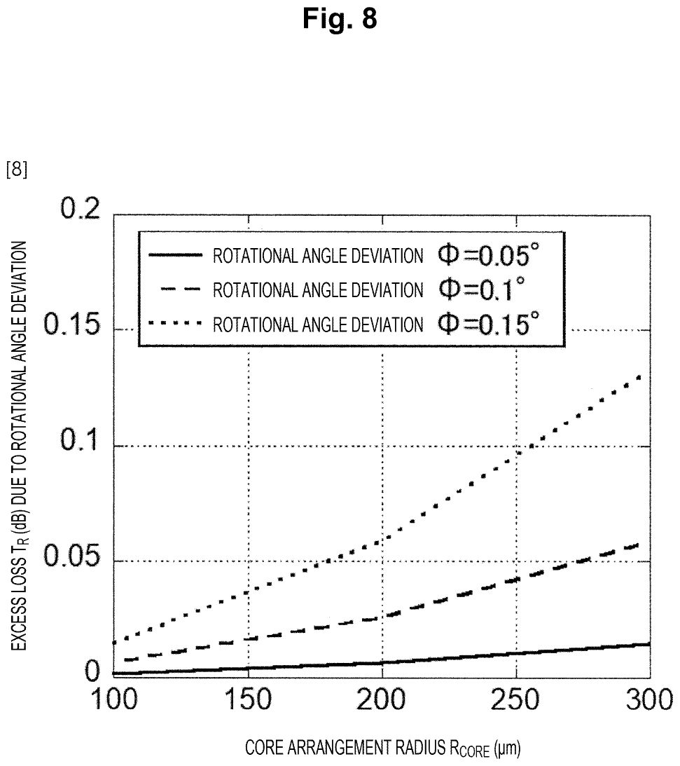

FIG. 8 illustrates an example of a relationship of the excess loss T_{R} due to a rotational angle deviation with respect to the core arrangement radius Rcore. FIG. 8 is a diagram illustrating the relationship between the core arrangement radius Rcore and the excess loss T_{R} due to a rotational angle deviation when the rotational angle deviation Φ is 0.05 degrees, 0.1 degrees, or 0.15 degrees. The excess loss increases as the core arrangement radius Rcore increases. However, for example, when the mode field radii ω₁ and ω₂ are 4.5 μm (MFD=9 μm), the excess loss T_{R} due to a rotational angle deviation can be maintained at 0.1 dB or less even at a rotational angle deviation of 0.15 degrees when the core arrangement radius is 250 μm or less.

Note that, in the above-described embodiment, an example in which the angle θ is set to 4.5 degrees or more in order to realize the reflection attenuation amount R of 40 dB or more has been described, but the present disclosure is not limited thereto. The angle θ may be any angle that can realize a desired reflection attenuation amount R. Furthermore, as the curvature radius Rcur of the convex spherical shape of the present disclosure, any numerical value corresponding to the angle θ can be adopted.

According to the present disclosure, since the end surface of the optical fiber disposed in the cylindrical multi-fiber ferrule has an oblique shape, good reflection characteristics can be realized. In addition, since axial adjustment is performed by the ferrule and the sleeve, it is possible to reduce excess loss due to axial deviation. Furthermore, in the optical connector using the cylindrical multi-fiber ferrule of the present disclosure, by including a mechanism for controlling rotation and fixation in one ferrule, it is possible to fix axial rotation at a position where incident light from an opposing optical fiber is maximized, that is, at a position where connection loss is minimized, at the time of manufacturing the connector. Therefore, it is possible to realize an optical connector in which excess loss due to rotational deviation is reduced.

### First Embodiment

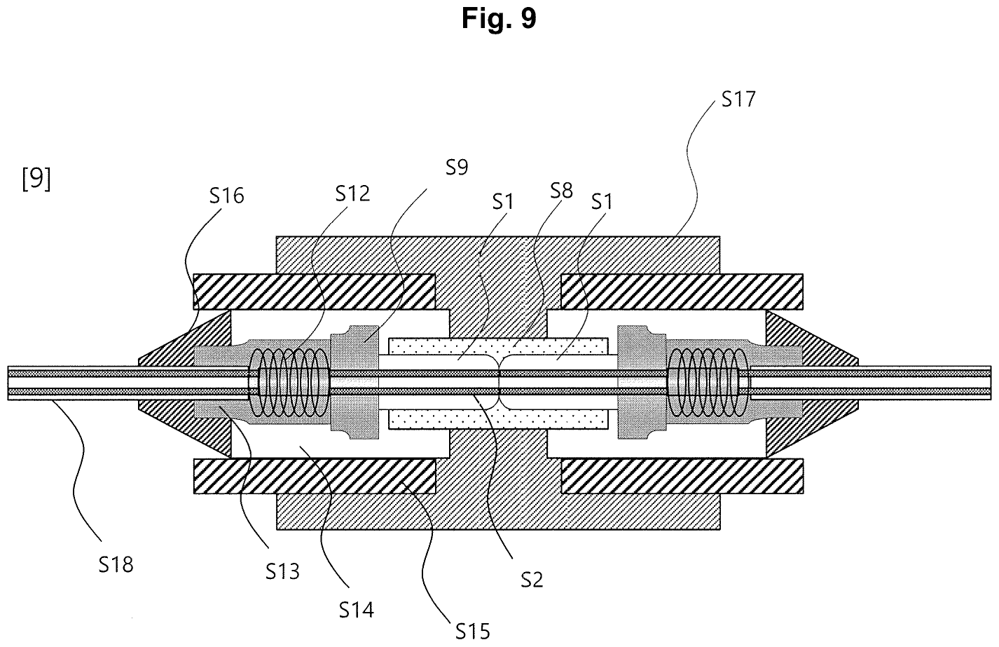

FIG. 9 is a schematic diagram illustrating a fitting form of an optical coupling portion in an optical connector according to a first embodiment of the present disclosure. The two ferrules S1 are inserted into the sleeve S8 so as to face each other, and the ferrule tip end portions of the two ferrules S1 come into contact with each other by applying pressure by springs S12. As a result, in the present embodiment, the optical fibers S2 are connected in a state where a gap is provided between the end surfaces of the optical fiber S2. In order to facilitate attachment and detachment in connection, the sleeve S8 is incorporated in an adapter S17, and each of the two ferrules S1 is incorporated in a plug frame S14 attached to a housing S15.

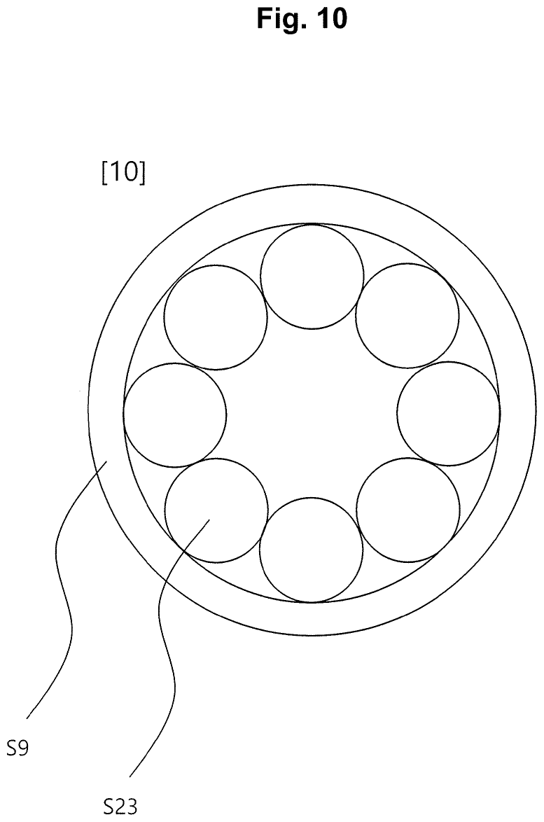

Each of the two ferrules S1 is attached with a flange S9 for protecting the optical fibers S2. As illustrated in FIG. 10, the optical fibers can be easily inserted into the ferrule by inserting a plurality of capillaries S23 into the flange S9 and arranging the capillaries S23 at the same positions as through holes for holding the optical fibers.

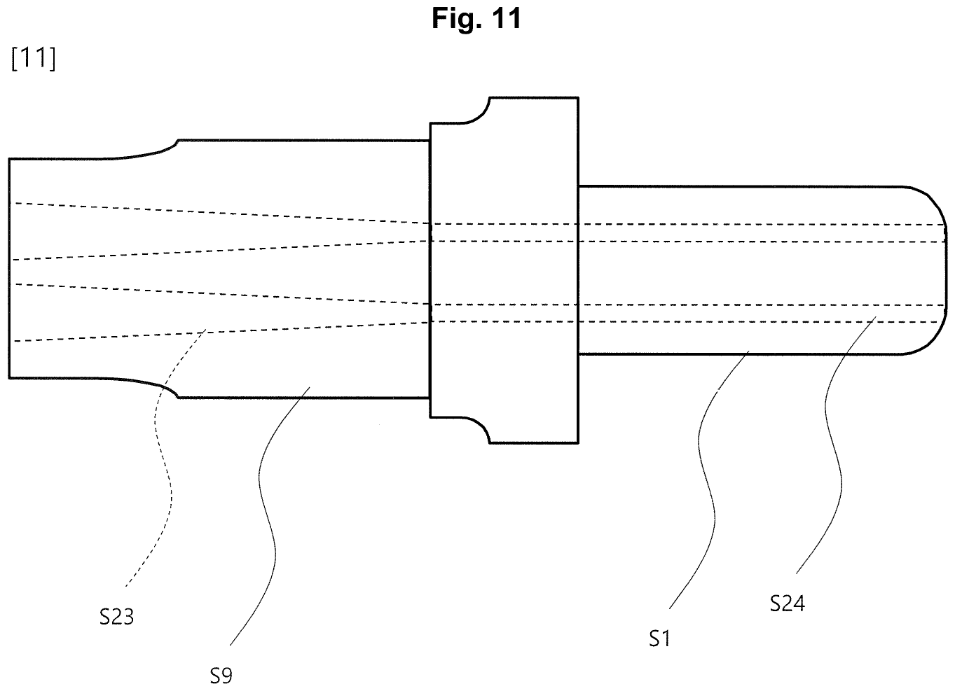

As illustrated in FIG. 11, by tapering each of the capillaries S23 in the longitudinal direction and making the diameter of the tip end of the tapered shape close to the diameter of a through hole S24 for holding the optical fiber, it is possible to prevent the optical fiber from being caught due to a step when the optical fiber is inserted into the ferrule S1 and to prevent the optical fiber from being broken.

Although the example in which the plurality of capillaries S23 are inserted into the flange S9 has been described in the present embodiment, the present invention is not limited thereto as long as the optical fibers have a shape that allows the optical fibers to be inserted into the through holes of the ferrule S1 and that can protect the optical fibers at the time of manufacturing the optical connector.

The flange S9 attached to one of the two ferrules S1 is provided with a cutout (not illustrated), and axial rotation of the cutout of the flange S9 is fixed by a cutout guide provided in the plug frame S14. The other ferrule S1 is attached with a mechanism (not illustrated) that enables rotation and fixation inside the plug frame S14.

When an optical connector is manufactured, that is, when the optical fibers are connected, a housing (connector plug) incorporating a ferrule attached with a flange with a cutout is inserted into one side of an adapter, a housing (connector plug) attached with a ferrule that can be rotated and fixed inside a plug frame is inserted into the other side of the adapter, a device (for example, a light source and a light receiver) capable of transmitting and receiving is attached to each of the optical fibers, the ferrule is rotated while monitoring an optical signal, and axial rotation of the ferrule is fixed at a position where received light power is maximized, and thereby a low-loss optical connector can be manufactured.

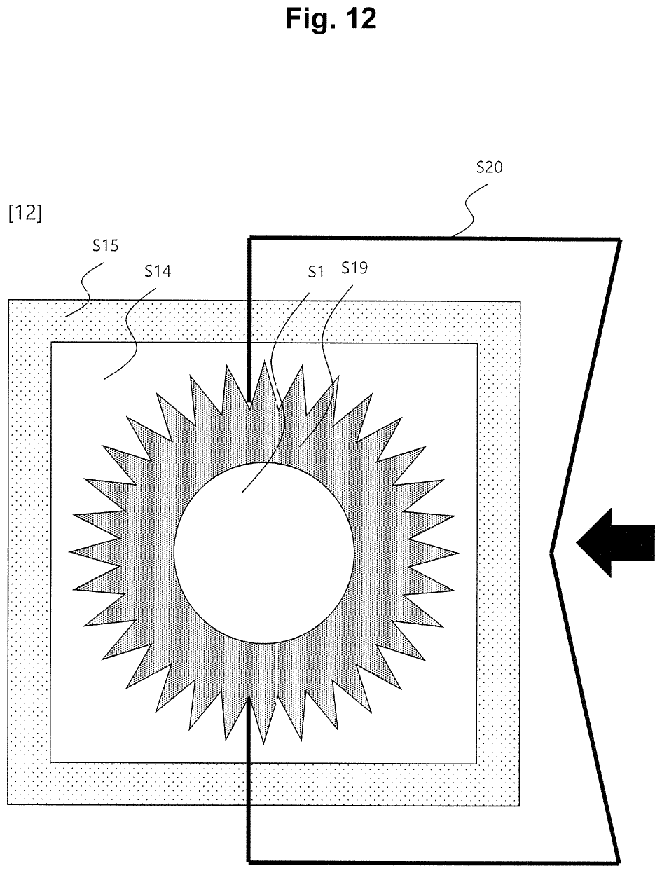

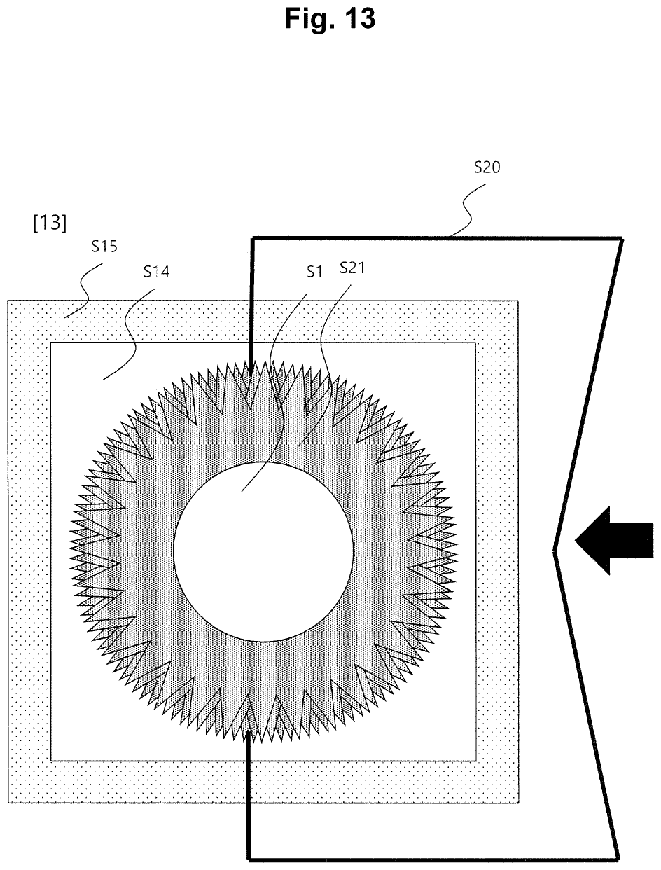

FIG. 12 is a diagram illustrating an example of a mechanism capable of rotating and fixing the ferrule inside the plug frame according to the first embodiment of the present disclosure. FIG. 12 is a cross-sectional view of a connector plug attached with the mechanism capable of rotating and fixing the ferrule S1 inside the plug frame S14. A grooved flange S19 is attached to the ferrule S1, and a fixing spring S20 is attached in a shape in which tip ends thereof are sandwiched between the grooves. By pressing the fixing spring S20 in the direction of the arrow in the drawing, the tip ends of the fixing spring S20 are detached from the grooves of the grooved flange S19, which enables the grooved flange S19 to axially rotate. By releasing the pressing force of the fixing spring S20 at a position where the monitored received light power is maximized, the grooved flange S19 is fixed, that is, the ferrule S1 is fixed, and the axial rotation direction of the inserted optical fibers is fixed. For example, as illustrated in FIG. 13, by attaching a plurality of annular portions S21 provided with grooves to the flange in an overlapping manner, it is possible to perform finer rotation angle control.

### Second Embodiment

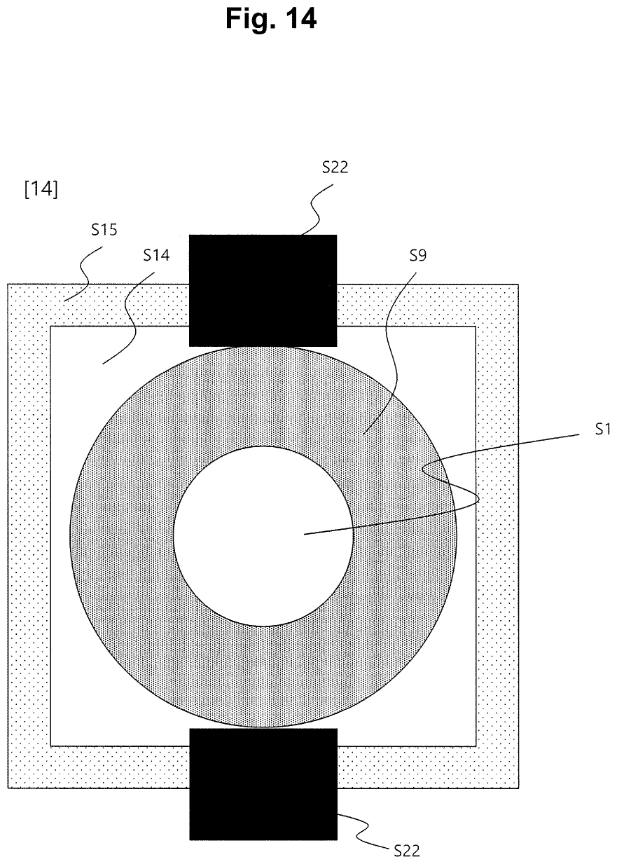

FIG. 14 is a diagram illustrating an example of a mechanism capable of rotating and fixing the ferrule inside the plug frame according to a second embodiment of the present disclosure. FIG. 14 is a cross-sectional view of a connector plug attached with the mechanism capable of rotating and fixing the ferrule inside the plug frame. The flange S9 is attached to the ferrule S1, and a fixing magnet S22 is attached to the outside of the flange S9. By detaching the fixing magnet S22, the flange S9 is enabled to axially rotate and by attaching the fixing magnet S22 at a position where the monitored received light power is maximized, the flange S9 is fixed, that is, the ferrule S1 is fixed, and the axial rotation direction of the inserted optical fibers is fixed. Here, the flange S9 may be made of a material having magnetism.

### Effects of Present Disclosure

According to the present disclosure, in an optical coupling portion used for collectively connecting a plurality of ports using single-mode optical fibers, arranging a plurality of single-core optical fibers in a cylindrical multi-fiber ferrule enables the plurality of optical fibers to be easily connected. Here, since a single-core single-mode fiber that is generally used is used as an optical fiber to be used similarly to a normal optical connector, a device such as a fan-in/fan-out is not required in wiring between transmission/reception devices, and simple and economical optical connection can be realized.

Furthermore, since the end surface of the optical fiber disposed in the cylindrical multi-fiber ferrule has an oblique shape, good reflection characteristics can be realized.

In addition, since axial adjustment is performed by the ferrule and a sleeve, it is possible to reduce excess loss due to axial deviation. Furthermore, in an optical connector using the cylindrical multi-fiber ferrule of the present disclosure, since one ferrule is provided with a mechanism for controlling rotation and fixation, it is possible to fix axial rotation at a position where incident light from an opposing optical fiber is maximized, that is, at a position where connection loss is minimized, at the time of manufacturing the connector. Therefore, an effect of reducing excess loss due to rotational deviation is obtained.

### INDUSTRIAL APPLICABILITY

The cylindrical multi-fiber ferrule and the optical connector according to the present disclosure use a single-core single-mode fiber generally used similarly to a normal optical connector as a connection technology for collectively connecting a plurality of ports by the optical fibers. Therefore, a device such as a fan-in/fan-out is not required as a transmission path configuration, and simple and economical optical connection can be achieved. In addition, since the end surface of the optical fiber disposed in the cylindrical multi-fiber ferrule has an oblique shape, excellent optical characteristics are achieved, which have good reflection characteristics and reduce excess loss due to axial deviation. Furthermore, in the optical connector using the cylindrical multi-fiber ferrule of the present disclosure, since one ferrule is provided with a mechanism for controlling rotation and fixation, it is possible to provide an optical connector in which excess loss due to rotational deviation is reduced. As a result, it is possible to use a plurality of single-mode optical fibers in an optical fiber network as a technology of collectively connecting the plurality of single-mode optical fibers in various facilities.

### REFERENCE SIGNS LIST

S1 Ferrule
S2 Optical fiber
S8 Sleeve
S9 Flange
S10 Length in sleeve axial direction
S12 Spring
S13 Stop ring
S14 Plug frame
S15 Housing
S16 Boot
S17 Adapter
S18 Cord coating
S19 Grooved flange
S20 Fixing spring
S21 Annular portion provided with grooves
S22 Fixing magnet
S23 Capillary
S24 Through hole

1. A cylindrical multi-fiber ferrule having a cylindrical shape, wherein a plurality of through holes are formed on a same circle centered on a central axis of the cylindrical shape, each of the through holes being configured to hold a single-core optical fiber, and
one ferrule tip end portion on the central axis has a convex spherical shape.

2. The cylindrical multi-fiber ferrule according to claim 1, wherein an angle formed by a plane perpendicular to the central axis and the through hole in the ferrule tip end portion is 4.5 degrees or more.

3. The cylindrical multi-fiber ferrule according to claim 2, wherein a curvature radius of the convex spherical shape is 0.5 mm or more and 3.2 mm or less.

4. The cylindrical multi-fiber ferrule according to claim 3, wherein a distance from the central axis of the cylindrical multi-fiber ferrule to a central axis of the through hole is 250 μm or less.

5. An optical connector, wherein a plurality of the cylindrical multi-fiber ferrules according to claim 1 are arranged facing each other, and
the ferrule tip end portions of two of the cylindrical multi-fiber ferrules arranged to face each other are butted against each other.

6. The optical connector according to claim 5, wherein the through holes of the two cylindrical multi-fiber ferrules arranged to face each other hold respective single-core optical fibers, and
a gap between end surfaces of the single-core optical fibers held by the respective cylindrical multi-fiber ferrules is 22 μm or less.

7. The optical connector according to claim 5, wherein an angle formed by a plane perpendicular to the central axis and end surfaces of the single-core optical fibers in the ferrule tip end portion is 4.5 degrees or more.
